(19) United States
(12) Patent Application Publication
(10) Pub. No.: US 2014/0198855 A1
(43) Pub. Date: Jul. 17, 2014

(54) SQUARE BLOCK PREDICTION

(71) Applicant: QUALCOMM Incorporated, San Diego, CA (US)

(72) Inventors: Joel Sole Rojals, La Jolla, CA (US); Marta Karczewicz, San Diego, CA (US)

(73) Assignee: QUALCOMM Incorporated, San Diego, CA (US)

(21) Appl. No.: 14/153,284

(22) Filed: Jan. 13, 2014

Related U.S. Application Data
(60) Provisional application No. 61/752,381, filed on Jan. 14, 2013.

(51) Int. Cl. H04N 19/593

(52) U.S. Cl. CPC H04N 19/00763
USPC 375/240.16

(57) ABSTRACT

Systems, devices, and methods for coding video data may limit an intra-prediction angle to predict a chroma component from a reference array. The limited intra-prediction angle used varies between a value that is less than or equal to a maximum intra-prediction angle of a luma component. The systems, devices, and methods for coding video data may code a chroma intra-coded current block based on the limited intra-prediction angle. In another example, systems devices, and methods for coding video data may extend the reference array based on reference values that are outside the reference array in a video coding scheme including a number of intra-prediction angles, store prediction values in the extended reference array, and intra-coding a current block based on at least the prediction values in the extended reference array.

This application claims the benefit of U.S. Provisional Application No. 61/752,381, filed Jan. 14, 2013, which is hereby incorporated by reference in its entirety.

### TECHNICAL FIELD

This disclosure relates to video coding, and more particularly to techniques for intra coding of video blocks.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards, to transmit, receive, and store digital video information more efficiently.

Video compression techniques include spatial prediction and/or temporal prediction to reduce or remove redundancy inherent in video sequences. For block-based video coding, a video picture or slice may be partitioned into blocks. A video picture alternatively may be referred to as a picture. Each block can be further partitioned. Blocks in an intra-coded (I) picture or slice are encoded using spatial prediction with respect to reference samples in neighboring blocks in the same picture or slice. Blocks in an inter-coded (P or B) picture or slice may use spatial prediction with respect to reference samples in neighboring blocks in the same picture or slice or temporal prediction with respect to reference samples in other reference pictures. Spatial or temporal prediction results in a predictive block for a block to be coded. Residual data represents pixel differences between the original block to be coded and the predictive block.

An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in a particular order to produce a one-dimensional vector of transform coefficients for entropy coding.

### SUMMARY

In general, this disclosure is related to intra-coding techniques for square block prediction. As one example, the techniques may be related for the chroma components, such as square block prediction in 4:2:2 chroma format. For instance, the techniques may utilize new angles for square blocks when square transforms are used in 4:2:2 format. In some examples, the techniques may limit the angles, so no reference samples are used beyond the defined array. In some examples, the techniques may extend the arrays. In some examples, the techniques may limit the angles and extend the arrays.

In one example, the disclosure describes a method for decoding video data in a video decoding scheme in a 4:2:2 chroma format, the method comprising limiting an intra-prediction angle to predict a chroma component from a reference array, wherein the limited intra-prediction angle used varies between a value that is less than or equal to a maximum intra-prediction angle of a luma component and decoding a chroma intra-coded current block based on the limited intra-prediction angle.

In another example, the disclosure describes a method for decoding video data, the method comprising extending a reference array based on reference values that are outside the reference array in a video decoding scheme including a number of intra-prediction angles, storing prediction values in the extended reference array, and decoding an intra-coded current block based on at least the prediction values in the extended reference array.

In another example, the disclosure describes a method for encoding video data in a video encoding scheme in a 4:2:2 chroma format, the method comprising limiting an intra-prediction angle to predict a chroma component from a reference array, wherein the limited intra-prediction angle used varies between a value that is less than or equal to a maximum intra-prediction angle of a luma component and intra-coding a current chroma block based on the limited intra-prediction angle.

In another example, the disclosure describes a method for encoding video data, the method comprising extending a reference array based on reference values that are outside the reference array in a video encoding scheme including a number of intra-prediction angles, storing prediction values in the extended reference array, and intra-coding a current block based on at least the prediction values in the extended reference array.

In another example, the disclosure describes an apparatus for decoding video data in a video decoding scheme in a 4:2:2 chroma format, the apparatus comprising one or more processors configured to limit an intra-prediction angle to predict a chroma component from a reference array, wherein the limited intra-prediction angle used varies between a value that is less than or equal to a maximum intra-prediction angle of a luma component and decode a chroma intra-coded current block based on the limited intra-prediction angle.

In another example, the disclosure describes an apparatus for decoding video data, the apparatus comprising extending a reference array based on reference values that are outside the reference array in a video decoding scheme including a number of intra-prediction angles, storing prediction values in the extended reference array, and decoding an intra-coded current block based on at least the prediction values in the extended reference array.

In another example, the disclosure describes an apparatus for encoding video data in a video encoding scheme in a 4:2:2 chroma format, the apparatus comprising one or more processors configured to limit an intra-prediction angle to predict a chroma component from a reference array, wherein the limited intra-prediction angle used varies between a value that is less than or equal to a maximum intra-prediction angle of a luma component and intra-code a current block based on the limited intra-prediction angles.

In another example, the disclosure describes an apparatus for encoding video data, the apparatus comprising extending a reference array based on reference values that are outside the reference array in a video encoding scheme including a number of intra-prediction angles, storing prediction values in the extended reference array, and intra-coding a current block based on at least the prediction values in the extended reference array.

In another example, the disclosure describes an apparatus for coding video data in a video coding scheme having a number of intra-prediction angles comprising means for limiting an intra-prediction angle to predict a chroma component from a reference array, wherein the limited intra-prediction angle used varies between a value that is less than or equal to a maximum intra-prediction angle of a luma component and means for decoding a chroma intra-coded current block based on the limited intra-prediction angle.

In another example, the disclosure describes an apparatus for coding video data comprising means for extending a reference array based on reference values that are outside the reference array in a video coding scheme including a number of intra-prediction angles, means for storing prediction values in the extended reference array, and means for intra-coding a current block based on at least the prediction values in the extended reference array.

In another example, the disclosure describes a non-transitory computer readable storage medium storing instructions that upon execution by one or more processors, cause the one or more processors to limit an intra-prediction angle to predict a chroma component from a reference array, wherein the limited intra-prediction angle used varies between a value that is less than or equal to a maximum intra-prediction angle of a luma component and decode a chroma intra-coded current block based on the limited intra-prediction angle.

In another example, the disclosure describes a non-transitory computer readable storage medium storing instructions that upon execution by one or more processors, cause the one or more processors to extend a reference array based on reference values that are outside the reference array in a video coding scheme including a number of intra-prediction angles, store prediction values in the extended reference array, and intra-code a current block based on at least the prediction values in the extended reference array.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may use one or more example techniques of this disclosure.

FIG. 2 is a block diagram illustrating an example of a video encoder that may use one or more example techniques of this disclosure.

FIG. 3 is a block diagram illustrating an example of a video decoder that may use one or more example techniques of this disclosure.

FIGS. 4A-4C are conceptual diagrams illustrating different color sample formats for luma and chroma components of a coding unit.

FIG. 5A is a graph illustrating intra-prediction 32.

FIG. 5B is a graph illustrating derived angle steps for the intra-prediction modes of FIG. 5A.

FIG. 6A is a conceptual diagram illustrating a luma component of a transform unit (TU) undergoing intra-prediction.

FIG. 6B is a conceptual diagram illustrating samples that cover corresponding luma areas.

FIG. 6C is a conceptual diagram illustrating the samples of FIG. 6B as squares.

FIG. 7 is a flowchart illustrating an example method for coding video data including limiting the number of intra-prediction angles in accordance with the systems and methods described herein.

FIG. 8 is a flowchart illustrating another example method for coding video data including extending a reference array in accordance with the systems and methods described herein.

### DETAILED DESCRIPTION

This disclosure is generally related to the field of video coding and compression. As one example, the disclosure is related to the high efficiency video coding (HEVC) standard currently under development. The term “coding” refers to encoding and decoding, and the techniques may apply to encoding, decoding or both encoding and decoding. As described in more detail, the techniques may be related to intra-coding (e.g., intra-prediction) in which a block within a picture is predicted with respect to another block or blocks in the same picture (i.e., spatial prediction).

As one example, the techniques may be related for the chroma components, such as square block prediction in 4:2:2 chroma format. The 4:2:2 format may use a square “Y” block and rectangular “U” and “V” blocks. A luminance component may be denoted as Y, and two different chrominance components may be denoted as U and V respectively. In order to avoid the use of rectangular transforms, an N×2N rectangular prediction block may be broken into two N×N square prediction blocks. When an N×2N rectangular prediction block is broken into two N×N square prediction blocks so that a square transform may be applied to each N×N square prediction block to transform the N×2N rectangular prediction block this may cause a break in the general HEVC structure in which the reconstruction is done after a transform. For example, generally a prediction angle for the N×2N rectangular prediction block will not be the same as a prediction angle for an N×N square prediction block except for certain angles, such as a vertical angle or a horizontal angle. Accordingly, when breaking an N×2N rectangular block into two N×N square prediction blocks the prediction angles of the N×2N rectangular prediction block may be considered and a modified angle may be used for the N×N square prediction blocks. The techniques described herein may utilize new angles for square blocks when square transforms are used in 4:2:2 format, i.e., for rectangular “U” and “V” blocks denoting chrominance components. In some examples, the techniques may limit the angles associated with rectangular blocks to a subset of angles associated with square blocks, so that no reference samples are used beyond the defined array, such as for rectangular “U” and “V” blocks denoting chrominance components. For example, a video decoding scheme may have a number of intra-prediction angles. The complete set of angles may be used for inter-coding of square “Y” blocks (luma) in the 4:2:2 format or the complete set of angles may be used for inter-coding of “Y” blocks (luma) and “U” and “V” blocks (both chroma) in non-4:2:2 formats, e.g., 4:2:0 and 4:4:4. Some of the techniques described herein may limit the number of intra-prediction angles for inter-coding “U” and “V” blocks (chroma) to predict from a reference array in the video decoding scheme. The limited intra-prediction angle may be less than the number of intra-prediction angles in the video decoding scheme. In some examples, the techniques may extend the arrays for rectangular “U” and “V” blocks. In some examples, the techniques may limit the angles and extend the arrays rectangular “U” and “V” blocks.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. In addition, there is a new video coding standard, namely High-Efficiency Video Coding (HEVC), being developed by the Joint Collaboration Team on Video Coding (JCT-VC) of ITU-T Video Coding Experts Group (VCEG) and ISO/IEC Motion Picture Experts Group (MPEG).

A recent draft of the HEVC standard, referred to as “HEVC Working Draft 10” or “WD10,” is described in document JCTVC-L1003v34, Bross et al., “High efficiency video coding (HEVC) text specification draft 10 (for FDIS & Last Call),” Joint Collaborative Team on Video Coding (JCT-VC) of ITU-T SG16 WP3 and ISO/IEC JTC1/SC29/WG11, 12th Meeting: Geneva, CH, 14-23 January, 2013, which, as of Sep. 10, 2013, is downloadable from: http://phenix.int-evry.fr/jct/doc_end_user/documents/12_Geneva/wg11/JCTVC-L1003-v34.zip. The entire content of WD10 is hereby incorporated by reference.

Another recent Working Draft (WD) of HEVC, and referred to as HEVC WD9 hereinafter, is available, as of Sep. 10, 2013, from: http://phenix.int-evry.fr/jct/doc_end_user/documents/11_Shanghai/wg11/JCTVC-K1003-v13.zip, the entire content of which is incorporated by reference herein.

For purposes of understanding, range extensions 4:2:2: chroma format are described below. In general, luma components (luminance) and chroma components (chrominance) are used to define pixels within a picture. The luma component indicates luminance information and the chroma components indicate color information. There may be one luma component and two chroma components for each pixel. The described techniques may be applicable to other color formats.

The “HEVC Range Extensions” are described in document JCTVC-N1005_v3, Flynn et al., “High Efficiency Video Coding (HEVC) Range Extensions text specification: Draft 4,” Joint Collaborative Team on Video Coding (JCT-VC) of ITU-T SG16 WP3 and ISO/IEC JTC1/SC29/WG11, 13th Meeting: Incheon, KR, 18-26 Apr. 2013, which, as of Sep. 22, 2013, is downloadable from: http://phenix.it-sudparis.eu/jct/doc end user/current document.php?id=8139.

JCT-VC is considering a new profile for 4:2:2 and 4:4:4 color formats. For 4:2:2 format, the chroma components are downsampled by a factor of 2 in the horizontal direction compared with the luma component. There is no downsampling in the vertical direction. In the JCT-VC meeting in Shanghai (October 2012), it was decided to have, as basis of the software development for the chroma range extensions, the software provided by Sony (JCTVC-K0181), which is available, as of Sep. 10, 2013, from http://phenix.int-evry.fr/jct/doc_end_user/documents/11_Shanghai/wg11/JCTVC-K0181-v4.zip. This software was released in November as the HEVC range extensions software. This disclosure incorporates by reference herein the JCTVC-K0181 document in its entirety.

JCT-VC is considering a new profile for 4:2:2 and 4:4:4 color formats. For 4:2:2 format, the chroma components are downsampled by a factor of 2 in the horizontal direction compared with the luma component. There is no downsampling in the vertical direction. In the JCT-VC meeting in Shanghai (October 2012), it was decided to have, as basis of the software development for the chroma range extensions, the software provided by Sony (JCTVC-K0181), which is available, as of Sep. 10, 2013, from http://phenix.int-evry.fr/jct/doc_end_user/documents/11_Shanghai/wg11/JCTVC-K0181-v4.zip. This software was released in November as the HEVC range extensions software. This disclosure incorporates by reference herein the JCTVC-K0181 document in its entirety.

Rectangular versus square transforms in 4:2:2 format are discussed below. In 4:2:2 chroma format down-sampling impacts the transform unit (TU) sizes. For example, consider a coding unit (CU) of size 16 (width)×16 (height). Transform units (TUs) and coding units (CUs) are described in greater detail below. Consider that the residual quadtree (also described in more detail below) subdivides the CU into four 8×8 TUs for luma. Then, for chroma components, the size of the TUs is 4×8. If the maximum and minimum luma transform sizes are 32×32 and 4×4, respectively, then for 4:2:2 chroma components, 16×32, 8×16, and 4×8 transforms may be necessary. In the extended chroma format software, rectangular transforms corresponding to these sizes are used. This has impact on hardware complexity. In hardware, each transform size is typically implemented as a separate block. Thus, addition of rectangular transforms increases hardware complexity. Furthermore, use of rectangular transforms of these sizes also necessitates changes to quantization (adjusting the QP by ±3).

Alternatively, two square transforms of N×N can be used instead of an N×2N transform. The impact of this change is studied in the HEVC Range Extensions Core Experiment (CE) 1. Test 3 of this CE compares the performance of two square transforms versus one rectangular transform. In the CE, the intra prediction process is unmodified. Therefore, the intra prediction is done on rectangular blocks N×2N for the chroma components.

Rectangular block prediction for chroma is described below. Since the 4:2:2 format is only down-sampled in one direction, the area covered per pixel is rectangular. This implies that the usual HEVC intra angular prediction may need to be modified. Extension of HM7 to Support Additional Chroma Formats, JCTVC-J0191, which is available, as of Sep. 10, 2013, from http://phenix.int-evry.fr/jct/doc_{—}end_user/documents/10_Stockholm/wg11/JCTVC-J0191-v4.zip, proposed the doubling/halving the angle values for 4:2:2. The techniques described in JCTVC-J0191 are incorporated by reference herein in their entirety.

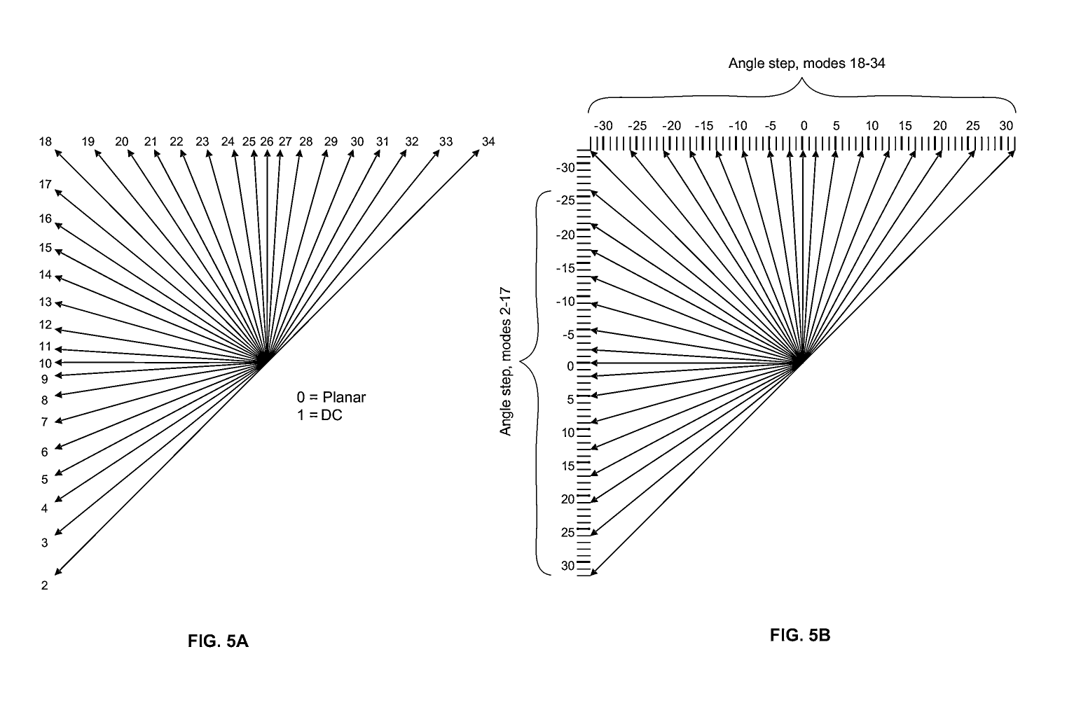

As discussed in JCTVC-J0191, the angle step and its inverse (currently referred to in the HM9.0 code as ‘intraPredAngle’ and ‘invAngle’) may be derived according to the same process used in HM9.0, as shown in FIGS. 5A and 5B. HM9.0 code may comprise software associated with the current HEVC Test Model (HM). As in HM9.0, for modes 18-34, the angle step intraPredAngle, when multiplied by the current sample's y-coordinate gives an offset (relative to the current x-coordinate, in units of 1/32 of a sample) to the reference sample to be used. The calculation being:

refX=(y+1)*intraPredAngle/32+x

For directions 18 to 25 (and may be and not necessarily up to 34), reference samples to the left of the top-left reference sample may be required, and are interpolated from the left-most column of reference samples using the invAngle. For modes 2-17, the transpose of the above algorithm is applied. For a vertical intra mode (18-34 inclusive), the derived angle step is halved and its inverse is doubled. Otherwise, for a horizontal intra mode (2-17 inclusive), the derived angle step is doubled and its inverse is halved.

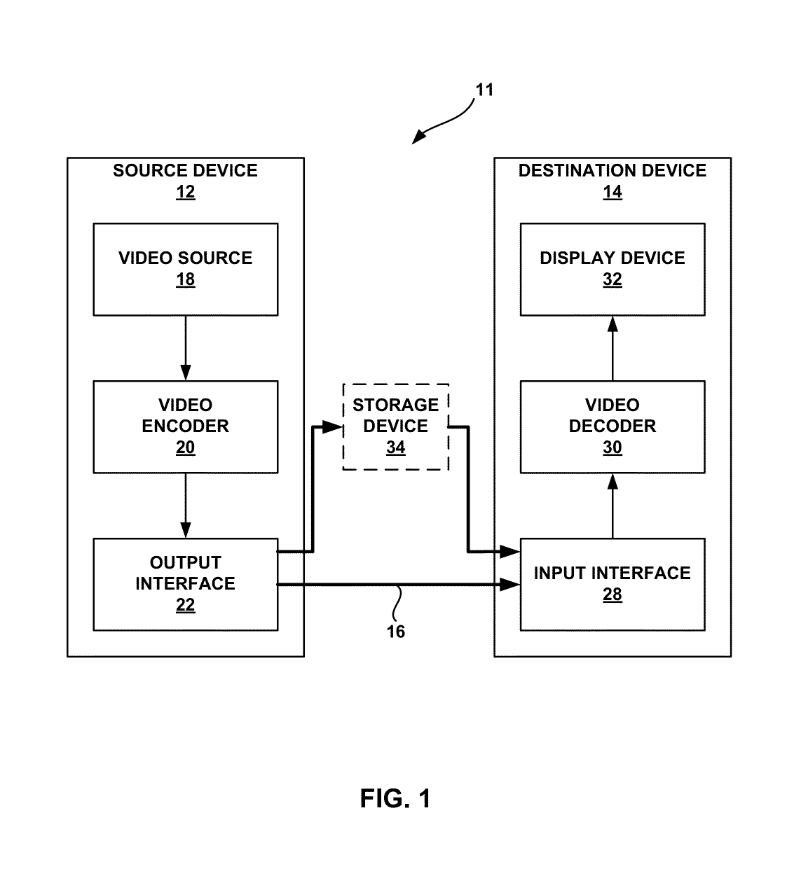

FIG. 1 is a block diagram illustrating an example video encoding and decoding system 11 that may utilize the techniques described in this disclosure. As shown in FIG. 1, decoding system 11 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless than or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 34. Similarly, input interface 28 may access encoded data from storage device 34. Storage device 34 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 34 may correspond to a file server or another intermediate storage device that may hold the encoded video generated by source device 12. Destination device 14 may access stored video data from storage device 34 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., digital subscriber line, cable modem, etc.), or a combination of both that is suitable for accessing encoded video data stored on a file server. The transmission of encoded video data from storage device 34 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, decoding system 11 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device. Some example video capture devices include a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. The techniques described in this disclosure may be applicable to video coding in general and may be applied to wireless and/or wired applications, however.

Video encoder 20 may encode the captured, pre-captured, or computer-generated video. The encoded video data may be transmitted directly to destination device 14 via output interface 22 of source device 12. The encoded video data may also (or alternatively) be stored onto storage device 34 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 34, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the HEVC standard presently under development, and may conform to the HM. Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. Other examples of video compression standards include MPEG-2 and ITU-T H.263.

The techniques of this disclosure, however, are not limited to any particular coding standard. Moreover, even if the techniques described in this disclosure may not necessarily conform to a particular standard, the techniques described in this disclosure may further assist in coding efficiency relative to the various standards. In addition, the techniques described in this disclosure may be part of future standards. For ease of understanding, the techniques are described with respect to the HEVC standard under development, but the techniques are not limited to the HEVC standard, and can be extended to other video coding standards or video coding techniques that are not defined by a particular standard.

Although not shown in FIG. 1, in some aspects, video encoder 20 and video decoder 30 may each be integrated with an audio encoder and decoder, and may include appropriate multiplexer-demultiplexer (MUX-DEMUX) units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, computer-readable storage medium such as a non-transitory computer-readable storage medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC is working on development of the HEVC standard. The HEVC standardization efforts are based on an evolving model of a video coding device referred to as the HM. The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU includes a coding node and prediction units (PUs) and transform units (TUs) associated with the coding node. A size of the CU corresponds to a size of the coding node and may be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

In general, a prediction unit (PU) includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., RefPicList0 (L0) or RefPicList1 (L1)) for the motion vector.

A TU may be used for the transform and quantization processes. In some examples, a TU may refer to a set of three transform blocks. These three transform blocks may include one luminance transform block and two chrominance transforms blocks that may be used for the transform and quantization processes. These three transform blocks may form a TU for a given block-sized area. A given CU having one or more PUs may also include one or more transform units (TUs). Following prediction, video encoder 20 may calculate residual values corresponding to the PU. The residual values comprise pixel difference values that may be transformed into transform coefficients, quantized, and scanned using the TUs to produce serialized transform coefficients for entropy coding. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

For example, for video coding according to the HEVC standard currently under development, a video picture may be partitioned into coding units (CUs), prediction units (PUs), and transform units (TUs). A CU generally refers to an image region that serves as a basic unit to which various coding tools are applied for video compression. A CU typically has a square geometry, and may be considered to be similar to a so-called “macroblock” under other video coding standards, such as, for example, ITU-T H.264.

To achieve better coding efficiency, a CU may have a variable size depending on the video data it contains. That is, a CU may be partitioned, or “split” into smaller blocks, or sub-CUs, each of which may also be referred to as a CU. In addition, each CU that is not split into sub-CUs may be further partitioned into one or more PUs and TUs for purposes of prediction and transform of the CU, respectively.

PUs may be considered to be similar to so-called partitions of a block under other video coding standards, such as H.264. PUs are the basis on which prediction for the block is performed to produce “residual” coefficients. Residual coefficients of a CU represent a difference between video data of the CU and predicted data for the CU determined using one or more PUs of the CU. Specifically, the one or more PUs specify how the CU is partitioned for the purpose of prediction, and which prediction mode is used to predict the video data contained within each partition of the CU.

One or more TUs of a CU specify partitions of a block of residual coefficients of the CU on the basis of which a transform is applied to the block to produce a block of residual transform coefficients for the CU. The one or more TUs may also be associated with the type of transform that is applied. The transform converts the residual coefficients from a pixel, or spatial domain to a transform domain, such as a frequency domain. In addition, the one or more TUs may specify parameters on the basis of which quantization is applied to the resulting block of residual transform coefficients to produce a block of quantized residual transform coefficients. The residual transform coefficients may be quantized to possibly reduce the amount of data used to represent the coefficients.

A CU generally includes one luminance component, denoted as Y, and two chrominance components, denoted as U and V. In other words, a given CU that is not further split into sub-CUs may include Y, U, and V components, each of which may be further partitioned into one or more PUs and TUs for purposes of prediction and transform of the CU, as previously described. For example, depending on the video sampling format, the size of the U and V components, in terms of a number of samples, may be the same as or different than the size of the Y component. As such, the techniques described above with reference to prediction, transform, and quantization may be performed for each of the Y, U, and V components of a given CU.

To encode a CU, one or more predictors for the CU are first derived based on one or more PUs of the CU. A predictor is a reference block that contains predicted data for the CU, and is derived on the basis of a corresponding PU for the CU, as previously described. For example, the PU indicates a partition of the CU for which predicted data is to be determined, and a prediction mode used to determine the predicted data. The predictor can be derived either through intra-(I) prediction (i.e., spatial prediction) or inter-(P or B) prediction (i.e., temporal prediction) modes. Hence, some CUs may be intra-coded (I) using spatial prediction with respect to neighboring reference blocks, or CUs, in the same frame, while other CUs may be inter-coded (P or B) with respect to reference blocks, or CUs, in other frames.

Upon identification of the one or more predictors based on the one or more PUs of the CU, a difference between the original video data of the CU corresponding to the one or more PUs and the predicted data for the CU contained in the one or more predictors is calculated. This difference, also referred to as a prediction residual, comprises residual coefficients, and refers to pixel differences between portions of the CU specified by the one or more PUs and the one or more predictors, as previously described. The residual coefficients are generally arranged in a two-dimensional (2-D) array that corresponds to the one or more PUs o the CU.

To achieve further compression, the prediction residual is generally transformed, e.g., using a discrete cosine transform (DCT), integer transform, Karhunen-Loeve (K-L) transform, or another transform. The transform converts the prediction residual, i.e., the residual coefficients, in the spatial domain to residual transform coefficients in the transform domain, e.g., a frequency domain, as also previously described. The transform coefficients are also generally arranged in a 2-D array that corresponds to the one or more TUs of the CU. For further compression, the residual transform coefficients may be quantized to possibly reduce the amount of data used to represent the coefficients, as also previously described.

To achieve still further compression, an entropy coder subsequently encodes the resulting residual transform coefficients, using Context Adaptive Variable Length Coding (CAVLC), Context Adaptive Binary Arithmetic Coding (CABAC), Probability Interval Partitioning Entropy Coding (PIPE), or another entropy coding methodology. Entropy coding may achieve this further compression by reducing or removing statistical redundancy inherent in the video data of the CU, represented by the coefficients, relative to other CUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up,” “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N. As described here, however, in some cases M may be equal to N such that square blocks may be used. The techniques described herein may utilize new angles for square blocks when square transforms are used in 4:2:2 format. In some examples, the techniques may limit the angles, so no reference samples are used beyond the defined array. In some examples, the techniques may extend the arrays. In some examples, the techniques may limit the angles and extend the arrays.

Following intra-predictive or inter-predictive coding using the PUs of a CU, video encoder 20 may calculate residual data for the TUs of the CU. The PUs may comprise pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in variable length coding (VLC) may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Video encoder 20 and video decoder 30 may be configured to implement the techniques described in this disclosure. For purposes of illustration, the following describes the techniques with respect to a video coder. One example of a video coder is video encoder 20. Another example of a video coder is video decoder 30.

As described herein, the techniques of this disclosure may be related to the chroma components of a video signal. One example may relate to a square block prediction in 4:2:2 chroma format. For instance, the techniques may utilize new angles for square blocks when square transforms are used in 4:2:2 format. Accordingly, the video coder may be configured to perform at least one of limit intra-prediction angles to predict from a reference array, and extend the reference array based on reference values that are outside the reference array. In some examples, video coder may be configured to both limit intra-prediction angles to predict from a reference array, and extend the reference array based on reference values that are outside the reference array. The video coder may be configured to intra-code a current block based on at least one of the limited intra-prediction angles and the extended reference array. In some examples, the video coder may be configured to intra-code the current block based on both the limited intra-prediction angles and the extended reference array.

In some examples, the video coder may clip the intra-prediction angles to limit the intra-prediction angles, and may also limit the inverse angles. For example, the video coder may clip the intra-prediction angles to a range of [−32, 32], for example, when the intra-prediction angles along at least one axis have been doubled to include angles from −64 to +64 and limit the inverse angles to a minimum of 256, for example, when inverse intra-prediction angles along at least one axis have been halved to include angles from −2048 to −128. In some examples, the video coder may limit the inverse angles to a minimum of 256 when prediction is not vertical or horizontal or inverse angle is 0. In some examples, the video coder may clip the intra-prediction angles based on an initial sign of the intra-prediction angles.

In examples where the video coder extends the reference array, the video coder may extend the reference array by using a last available reference value. For example, the video coder may set the reference value of the last available reference value equal to the reference value for one or more samples beyond the reference array.

A video coder such as video encoder 20 or video decoder 30 may code video data in a video decoding scheme in a 4:2:2 chroma format. The coder may limit an intra-prediction angle to predict a chroma component from a reference array. The limited intra-prediction angle used may vary between a value that is less than or equal to a maximum intra-prediction angle of a luma component. The video encoder 20 or video decoder 30 may code a chroma intra-coded current block or intra-code a current block based on the limited intra-prediction angle.

A video coder such as video encoder 20 or video decoder 30 may extende a reference array based on reference values that are outside the reference array in a video decoding scheme including a number of intra-prediction angles. The video coder may store prediction values in the extended reference array and decode an intra-coded current block based on at least the prediction values in the extended reference array.

A video coder such as video encoder 20 or video decoder 30 may code video data in a video coding scheme having a number of intra-prediction angles. The video coding scheme may include a 4:2:2 chroma format in some examples. The video coder may use a limited intra-prediction angle to predict from a reference array in the video decoding scheme. The limited intra-prediction angle may be less than the number of intra-prediction angles in the video decoding scheme. Limiting the intra-prediction angles may include clipping the intra-prediction angles and limiting inverse angels. The video coder may code an intra-coded current block based on the limited intra-prediction angles. In another example, the video coder may extend a reference array based on reference values that are outside the reference array in a video decoding scheme including a number of intra-prediction angles. As discussed above, in some examples, extending the array further comprised extending the reference array using a last available reference value by setting the reference value of the last available reference value equal to the reference value for one or more samples beyond the reference array. The video coder may store the intra-prediction angles in the reference array.

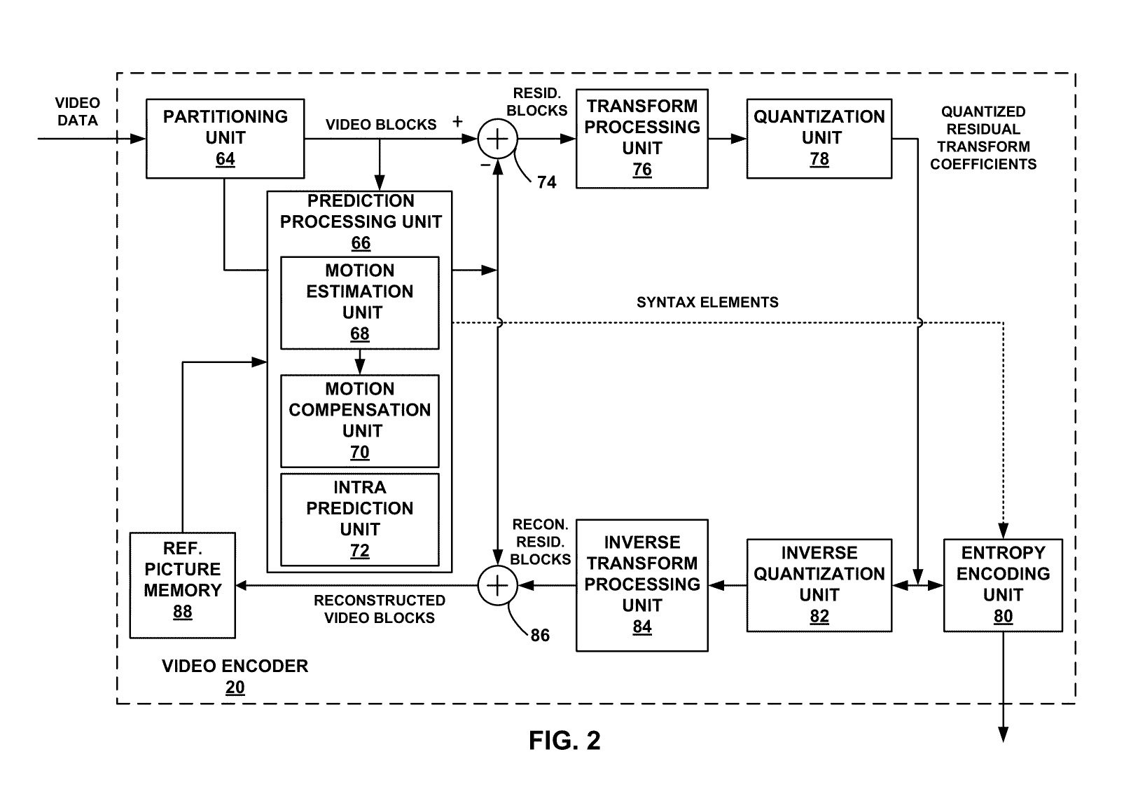

FIG. 2 is a block diagram illustrating an example video encoder 20 that may implement the techniques described in this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 2, video encoder 20 includes a partitioning unit 64, prediction processing unit 66, reference picture memory 88, summer 74, transform processing unit 76, quantization unit 78, and entropy encoding unit 80. Prediction processing unit 66 includes motion estimation unit 68, motion compensation unit 70, and intra-prediction unit 72. For video block reconstruction, video encoder 20 also includes inverse quantization unit 82, inverse transform processing unit 84, and summer 86. A deblocking filter (not shown in FIG. 2) may also be included to filter block boundaries to remove blockiness artifacts from reconstructed video. If desired, the deblocking filter would typically filter the output of summer 86. Additional loop filters (in loop or post loop) may also be used in addition to the deblocking filter.

As shown in FIG. 2, video encoder 20 receives video data, and partitioning unit 64 partitions the data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 66 may select one of a plurality of possible coding modes, such as one of a plurality of intra coding modes (i.e., intra-prediction) or one of a plurality of inter coding modes (i.e., inter-prediction), for the current video block based on error results (e.g., coding rate and the level of distortion). Prediction processing unit 66 may provide the resulting intra- or inter-coded block to summer 74 to generate residual block data and to summer 86 to reconstruct the encoded block for use as a reference picture.

Intra-prediction unit 72 within prediction processing unit 66 may perform intra-predictive coding of the current video block relative to one or more neighboring blocks in the same frame or slice as the current block to be coded to provide spatial compression. Motion estimation unit 68 and motion compensation unit 70 within prediction processing unit 66 perform inter-predictive coding of the current video block relative to one or more predictive blocks in one or more reference pictures to provide temporal compression.

Motion estimation unit 68 may be configured to determine the inter-prediction mode for a video slice according to a predetermined pattern for a video sequence. Motion estimation unit 68 and motion compensation unit 70 may be highly integrated, but are illustrated separately for conceptual purposes. Motion estimation, performed by motion estimation unit 68, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 88. For example, video encoder 20 may interpolate values of one-quarter pixel positions, one-eighth pixel positions, or other fractional pixel positions of the reference picture. Therefore, motion estimation unit 68 may perform a motion search relative to the full pixel positions and fractional pixel positions and output a motion vector with fractional pixel precision.

Motion estimation unit 68 calculates a motion vector for a PU of a video block in an inter-coded slice by comparing the position of the PU to the position of a predictive block of a reference picture. The reference picture may be selected from a first reference picture list (RefPicList0) or a second reference picture list (RefPicList1), each of which identify one or more reference pictures stored in reference picture memory 88. Motion estimation unit 68 sends the calculated motion vector to entropy encoding unit 80 and motion compensation unit 70.

Motion compensation, performed by motion compensation unit 70, may involve fetching or generating the predictive block based on the motion vector determined by motion estimation, possibly performing interpolations to sub-pixel precision. Upon receiving the motion vector for the PU of the current video block, motion compensation unit 70 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 74 represents the component or components that perform this subtraction operation. Motion compensation unit 70 may also generate syntax elements associated with the video blocks and the video slice for use by video decoder 30 in decoding the video blocks of the video slice.

Intra-prediction unit 72 may intra-predict a current block, as an alternative to the inter-prediction performed by motion estimation unit 68 and motion compensation unit 70, as described above. In particular, intra-prediction unit 72 may determine an intra-prediction mode to use to encode a current block. In some examples, intra-prediction unit 72 may encode a current block using various intra-prediction modes, e.g., during separate encoding passes, and intra-prediction unit 72 may select an appropriate intra-prediction mode to use from the tested modes. For example, intra-prediction unit 72 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction unit 72 may calculate ratios from the distortions and rates for the various encoded blocks to determine which intra-prediction mode exhibits the best rate-distortion value for the block.

In any case, after selecting an intra-prediction mode for a block, intra-prediction unit 72 may provide information indicative of the selected intra-prediction mode for the block to entropy encoding unit 80. Entropy encoding unit 80 may encode the information indicating the selected intra-prediction mode in accordance with the techniques of this disclosure.

After prediction processing unit 66 generates the predictive block for the current video block via either inter-prediction or intra-prediction, video encoder 20 forms a residual video block by subtracting the predictive block from the current video block. The residual video data in the residual block may be included in one or more TUs and applied to transform processing unit 76. Transform processing unit 76 transforms the residual video data into residual transform coefficients using a transform, such as a discrete cosine transform (DCT) or a conceptually similar transform. Transform processing unit 76 may convert the residual video data from a pixel domain to a transform domain, such as a frequency domain.

Transform processing unit 76 may send the resulting transform coefficients to quantization unit 78. Quantization unit 78 quantizes the transform coefficients to further reduce bit rate. The quantization process may reduce the bit depth associated with some or all of the coefficients. The degree of quantization may be modified by adjusting a quantization parameter. In some examples, quantization unit 78 may then perform a scan of the matrix including the quantized transform coefficients. Alternatively, entropy encoding unit 80 may perform the scan.

Following quantization, entropy encoding unit 80 entropy encodes the quantized transform coefficients. For example, entropy encoding unit 80 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 80, the encoded bitstream may be transmitted to video decoder 30, or archived for later transmission or retrieval by video decoder 30. Entropy encoding unit 80 may also entropy encode the motion vectors and the other syntax elements for the current video slice being coded.

Inverse quantization unit 82 and inverse transform processing unit 84 apply inverse quantization and inverse transformation, respectively, to reconstruct the residual block in the pixel domain for later use as a reference block of a reference picture. Motion compensation unit 70 may calculate a reference block by adding the residual block to a predictive block of one of the reference pictures within one of the reference picture lists. Motion compensation unit 70 may also apply one or more interpolation filters to the reconstructed residual block to calculate sub-integer pixel values for use in motion estimation. Summer 86 adds the reconstructed residual block to the motion compensated prediction block produced by motion compensation unit 70 to produce a reference block for storage in reference picture memory 88. The reference block may be used by motion estimation unit 68 and motion compensation unit 70 as a reference block to inter-predict a block in a subsequent video frame or picture.

In some examples, prediction processing unit 66 may be configured to perform the techniques of this disclosure. For example, prediction processing unit 66 may code video data in a video decoding scheme in a 4:2:2 chroma format. Prediction processing unit 66 may limit an intra-prediction angle to predict a chroma component from a reference array. The limited intra-prediction angle used may vary between a value that is less than or equal to a maximum intra-prediction angle of a luma component. Prediction processing unit 66 may code a chroma intra-coded current block or intra-code a current block based on the limited intra-prediction angle.

In another example, prediction processing unit 66 may extend a reference array based on reference values that are outside the reference array in a video decoding scheme including a number of intra-prediction angles. Prediction processing unit 66 may store prediction values in the extended reference array and decode an intra-coded current block based on at least the prediction values in the extended reference array.

In other examples, intra-prediction unit 72 or prediction processing unit 66 may perform various aspects of a decoding scheme having a number of intra-prediction angles. For example, intra-prediction unit 72 may limit the number of intra-prediction angles used to predict from a reference array in the video encoding scheme. The limited intra-prediction angle may be less than the number of intra-prediction angles in the video encoding scheme. Accordingly, video encoder 20 may intra-code a current block based on the limited intra-prediction angle. In some examples, intra-prediction unit 72 may limit the intra-prediction angles by clipping the intra-prediction angles. Intra-prediction unit 72 may also limit inverse angels. In some examples, limiting the inverse angels may also be accomplished by clipping.

However, aspects of this disclosure are not so limited. In other examples, some other unit of video encoder 20, such as a processor, or any other unit of video encoder 20 may be tasked to perform the techniques of this disclosure. In addition, in some examples, the techniques of this disclosure may be divided among one or more of the units of video encoder 20.

As described herein, the techniques of this disclosure may be related to the chroma components of a video signal. One example may relate to a square block prediction in 4:2:2 chroma format. For instance, the techniques may utilize new angles for square blocks when square transforms are used in 4:2:2 format. Accordingly, the video encoder 20 may be configured to perform at least one of limit intra-prediction angles to predict from a reference array, and extend the reference array based on reference values that are outside the reference array. In some examples, video encoder 20 may be configured to both limit intra-prediction angles to predict from a reference array, and extend the reference array based on reference values that are outside the reference array. Video encoder 20 may be configured to intra-code a current block based on at least one of the limited intra-prediction angles and the extended reference array. In some examples, video encoder 20 may be configured to intra-code the current block based on both the limited intra-prediction angles and the extended reference array.

In some examples, video encoder 20 may clip the intra-prediction angles to limit the intra-prediction angles, and may also limit the inverse angles. For example, video encoder 20 may clip the intra-prediction angles to a range of [−32, 32], and limit the inverse angles to a minimum of 256. In some examples, video encoder 20 may limit the inverse angles to a minimum of 256 when prediction is not vertical or horizontal or inverse angle is 0. In some examples, video encoder 20 may clip the intra-prediction angles based on an initial sign of the intra-prediction angles.

In examples where video encoder 20 extends the reference array, video encoder 20 may extend the reference array by using a last available reference value. For example, video encoder 20 may set the reference value of the last available reference value equal to the reference value for one or more samples beyond the reference array.

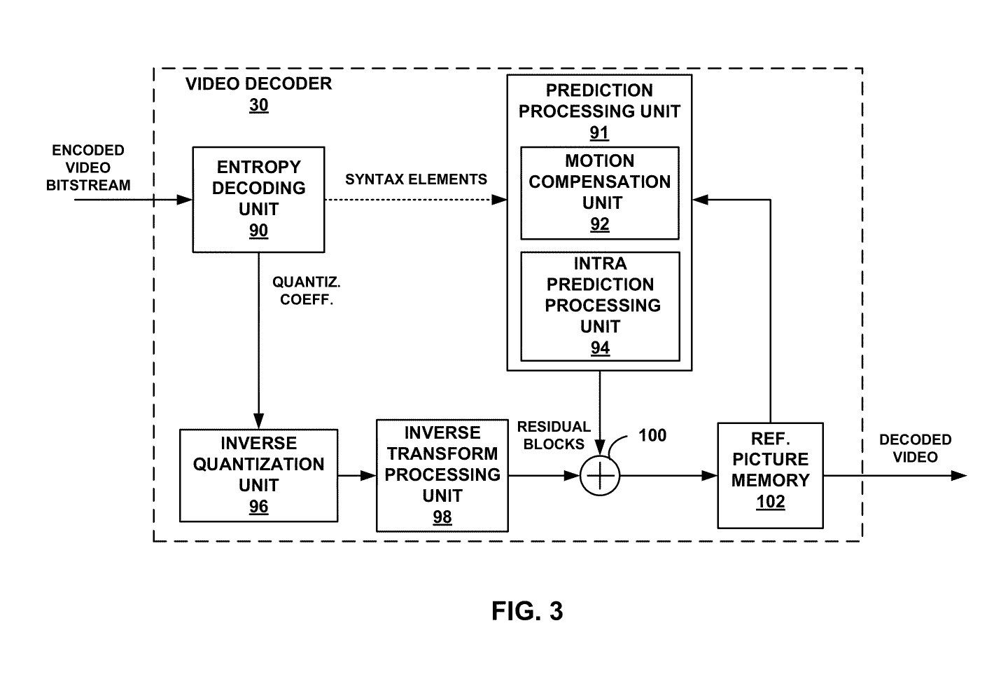

FIG. 3 is a block diagram illustrating an example video decoder 30 that may implement the techniques described in this disclosure. In the example of FIG. 3, video decoder 30 includes an entropy decoding unit 90, prediction processing unit 91, inverse quantization unit 96, inverse transformation processing unit 98, summer 100, and reference picture memory 102. Prediction processing unit 91 includes motion compensation unit 92 and intra-prediction processing unit 94. Video decoder 30 may, in some examples, perform a decoding pass generally reciprocal to the encoding pass described with respect to video encoder 20 from FIG. 2.

During the decoding process, video decoder 30 receives an encoded video bitstream that represents video blocks of an encoded video slice and associated syntax elements from video encoder 20. Entropy decoding unit 90 of video decoder 30 entropy decodes the bitstream to generate quantized coefficients, motion vectors, and other syntax elements. Entropy decoding unit 90 forwards the motion vectors and other syntax elements to prediction processing unit 91. Video decoder 30 may receive the syntax elements at the video slice level and/or the video block level.

When the video slice is coded as an intra-coded (I) slice, intra-prediction processing unit 94 of prediction processing unit 91 may generate prediction data for a video block of the current video slice based on a signaled intra prediction mode and data from previously decoded blocks of the current frame or picture. When the video picture is coded as an inter-coded (i.e., B or P) slice, motion compensation unit 92 of prediction processing unit 91 produces predictive blocks for a video block of the current video slice based on the motion vectors and other syntax elements received from entropy decoding unit 90. The predictive blocks may be produced from one of the reference pictures within one of the reference picture lists. Video decoder 30 may construct the reference picture lists, RefPicList0 and RefPicList1, using default construction techniques or any other technique based on reference pictures stored in reference picture memory 102.

Motion compensation unit 92 determines prediction information for a video block of the current video slice by parsing the motion vectors and other syntax elements, and uses the prediction information to produce the predictive blocks for the current video block being decoded. For example, motion compensation unit 92 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 92 may also perform interpolation based on interpolation filters. Motion compensation unit 92 may use interpolation filters as used by video encoder 20 during encoding of the video blocks to calculate interpolated values for sub-integer pixels of reference blocks. In this case, motion compensation unit 92 may determine the interpolation filters used by video encoder 20 from the received syntax elements and use the interpolation filters to produce predictive blocks.

Inverse quantization unit 96 inverse quantizes (i.e., de-quantizes), the quantized transform coefficients provided in the bitstream and decoded by entropy decoding unit 90. The inverse quantization process may include use of a quantization parameter calculated by video encoder 20 for each video block in the video slice to determine a degree of quantization and, likewise, a degree of inverse quantization that should be applied. Inverse transform processing unit 98 applies an inverse transform, e.g., an inverse DCT, an inverse integer transform, or a conceptually similar inverse transform process, to the transform coefficients in order to produce residual blocks in the pixel domain.

After motion compensation unit 92 generates the predictive block for the current video block based on the motion vectors and other syntax elements, video decoder 30 forms a decoded video block by summing the residual blocks from inverse transform processing unit 98 with the corresponding predictive blocks generated by motion compensation unit 92. Summer 100 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 102, which stores reference pictures used for subsequent motion compensation. Reference picture memory 102 also stores decoded video for later presentation on a display device, such as display device 32 of FIG. 1.

In some examples, prediction processing unit 91 may be configured to perform the techniques of this disclosure. For example, prediction processing unit 91 may code video data in a video decoding scheme in a 4:2:2 chroma format. Prediction processing unit 91 may limit an intra-prediction angle to predict a chroma component from a reference array. The limited intra-prediction angle used may vary between a value that is less than or equal to a maximum intra-prediction angle of a luma component. Prediction processing unit 91 may code a chroma intra-coded current block or intra-code a current block based on the limited intra-prediction angle.

In another example, prediction processing unit 91 may extend a reference array based on reference values that are outside the reference array in a video decoding scheme including a number of intra-prediction angles. Prediction processing unit 91 may store prediction values in the extended reference array and decode an intra-coded current block based on at least the prediction values in the extended reference array.

In another example, intra-prediction processing unit 94 of prediction processing unit 91 may perform various aspects of an encoding scheme having a number of intra-prediction angles. For example, intra-prediction processing unit 94 may limit the intra-prediction angles used to predict from a reference array in the video decoding scheme. The limited intra-prediction angles may be less than the number of intra-prediction angles in the video decoding scheme. Accordingly, video decoder 30 may intra-code a current block based on the limited intra-prediction angles. In some examples, intra-prediction processing unit 94 may limit the intra-prediction angles by clipping the intra-prediction angles. Intra-prediction processing unit 94 may also limit inverse angels. In some examples, limiting the inverse angels may also be accomplished by clipping.

However, aspects of this disclosure are not so limited. In other examples, some other unit of video encoder 20, such as a processor, or any other unit of video encoder 20 may be tasked to perform the techniques of this disclosure. In addition, in some examples, the techniques of this disclosure may be divided between one or more of the units of video encoder 20.

In one or more examples, a video decoder 30 may decode video data in a video coding scheme having a number of intra-prediction angles. Video decoder 30 may downsample chroma components of a picture that includes a current block relative to luma components of the picture. In some examples, intra-coding may include intra-coding downsampled chroma components of the current block. Downsampling chroma components may include downsampling chroma components prior to the at least one of limiting and extending.

In some examples, video decoder 30 may use a limited intra-prediction angle to predict from a reference array in the video decoding scheme. The limited intra-prediction angle may be less than the number of intra-prediction angles in the video decoding scheme. Limiting the intra-prediction angles may include clipping the intra-prediction angles and limiting inverse angels. Clipping the intra-prediction angles may include clipping the intra-prediction angles to a range of (−32, 32). This may be done, for example, when the intra-prediction angles along at least one axis have been doubled to include angles from −64 to +64. Limiting inverse angles may include limiting the inverse angles to a minimum of −256. This may be done, for example, when inverse intra-prediction angles along at least one axis have been halved to include angles from −2048 to −128. Limiting the inverse angles to the minimum of −256 may include limiting the inverse angles to the minimum of −256 when prediction is not vertical or horizontal or inverse angle is 0. Video decoder 30 may decode an intra-coded current block based on the limited intra-prediction angles.

In some examples, video decoder 30 may extend the reference array based on reference values that are outside the reference array, wherein intra-coding further comprises intra-coding the current block based on both the limited number intra-prediction angles and the extended reference array. Additionally, intra-coding 4:2:2 chroma components of the current block comprises intra-coding chroma components of a square block of a non-square block, wherein the non-square block forms the current block, and wherein the non-square block includes a plurality of square blocks.

Video decoder 30 may extend a reference array based on reference values that are outside the reference array in a video decoding scheme including a number of intra-prediction angles. In some examples, extending the array further comprised extending the reference array using a last available reference value by setting the reference value of the last available reference value equal to the reference value for one or more samples beyond the reference array.

Video decoder 30 may store the intra-prediction angles in the reference array. In examples where the video coder extends the reference array, the video coder may extend the reference array by using a last available reference value. For example, the video coder may set the reference value of the last available reference value equal to the reference value for one or more samples beyond the reference array.

Video decoder 30 may code an intra-coding current block based on at least the extended reference array. For example, video encoder 20 may encode an intra-coding current block based on at least the extended reference array or video decoder 30 may decode an intra-coding current block based on at least the extended reference array.

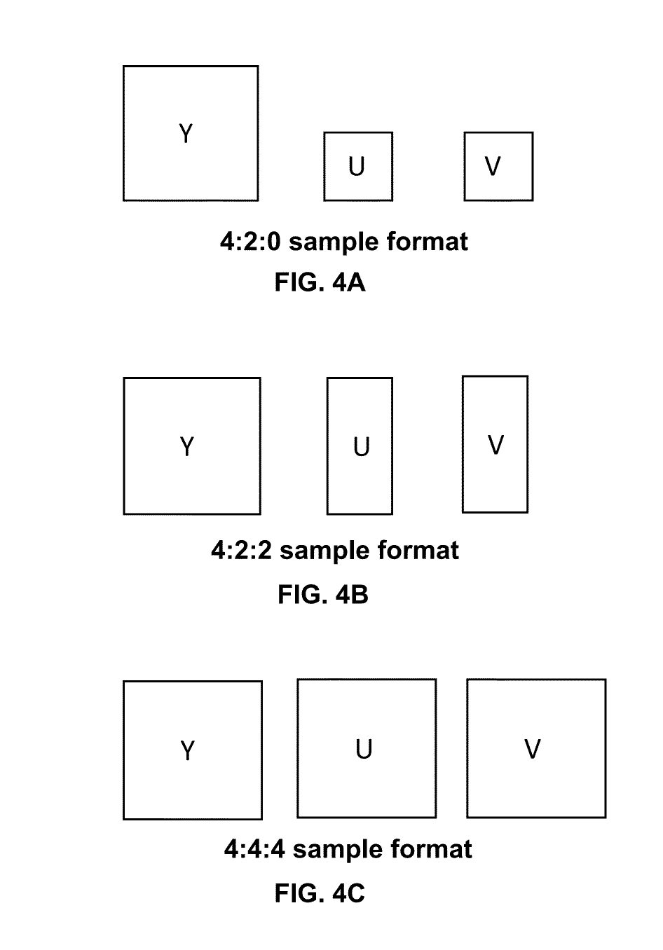

FIGS. 4A-4C are conceptual diagrams illustrating different sample formats for luma and chroma components of a coding unit. FIG. 4A is a conceptual diagram illustrating the 4:2:0 sample format. As illustrated in FIG. 4A, for the 4:2:0 sample format, the chroma components are one quarter of the size of the luma component. Thus, for a CU formatted according to the 4:2:0 sample format, there are four luma samples for every sample of a chroma component. FIG. 4B is a conceptual diagram illustrating the 4:2:2 sample format. As illustrated in FIG. 4B, for the 4:2:2 sample format, the chroma components are one half of the size of the luma component. Thus, for a CU formatted according to the 4:2:2 sample format, there are two luma samples for every sample of a chroma component. FIG. 4C is a conceptual diagram illustrating the 4:4:4 sample format. As illustrated in FIG. 4C, for the 4:4:4 sample format, the chroma components are the same size of the luma component. Thus, for a CU formatted according to the 4:4:4 sample format, there is one luma sample for every sample of a chroma component.

FIG. 5A is a graph illustrating intra-prediction modes. FIG. 5B is a graph illustrating derived angle steps for the intra-prediction modes of FIG. 5A. For example,

FIG. 5A illustrates modes 2-34, indicated by the numeral at the end of the arrow. In FIG. 5A, modes 2-17 are illustrated in the vertical direction, and modes 18-34 are illustrated in the horizontal direction. In FIG. 5B, angle step for modes 2-17 are illustrated in the vertical direction, and angle step for modes 18-34 are illustrated in the horizontal direction.

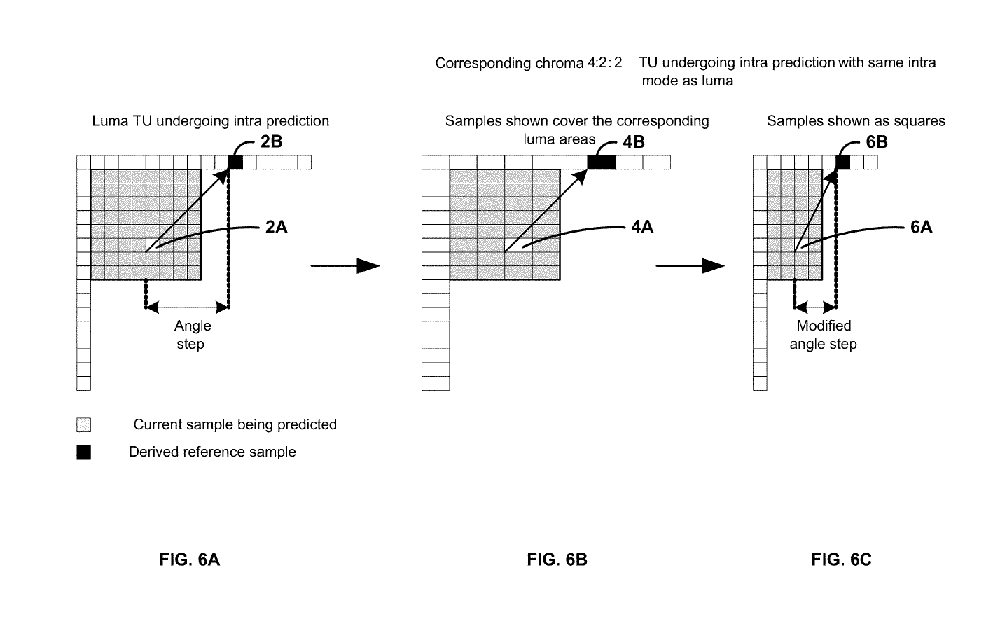

A modification to the angle step may be desirable in order to ensure that the projection from the current sample to be predicted points to a valid reference sample, as illustrated in FIGS. 6A-6C. In various examples, intra-prediction unit 72 (FIG. 2) or intra-prediction processing unit 94 (FIG. 3) may modify the angle step in order to ensure that the projection from the current sample to be predicted points to a valid reference sample. In software, which may be running on intra-prediction unit 72 or prediction processing unit 66 or intra-prediction processing unit 94 prediction processing unit 91, the change in the C-code is the following:

if ((channelType == CHANNEL_TYPE_CHROMA) && (format ==
CHROMA_422))
{

intraPredAngle = bIsModeVer ? (intraPredAngle>>1) :
2*intraPredAngle;
invAngle = bIsModeVer ? 2*invAngle : (invAngle>>1);

}

FIG. 6A is a conceptual diagram illustrating a luma component of a transform unit (TU) undergoing intra-prediction. FIG. 6B is a conceptual diagram illustrating samples that cover corresponding luma areas. FIG. 6C is a conceptual diagram illustrating the samples of FIG. 6B as squares. In FIGS. 6A-6C, reference numerals 2A, 4A, and 6A refer to the current sample being predicted, respectively. In FIGS. 6A-6C, reference numerals 2B, 4B, and 6B refer to the derived reference sample, respectively.

Some issues are described below. When an N×2N rectangular prediction block is broken into two N×N square prediction blocks so that a square transform may be applied to each N×N square prediction block to transform the N×2N rectangular prediction block this may cause a break in the general HEVC structure in which the reconstruction is done after a transform. For example, generally a prediction angle for the N×2N rectangular prediction block will not be the same as a prediction angle for an N×N square prediction block except for certain angles, such as a vertical angle or a horizontal angle. Accordingly, when breaking an N×2N rectangular block into two N×N square prediction blocks the prediction angles of the N×2N rectangular prediction block may be considered and a modified angle may be used for the N×N square prediction blocks. In an example, a second N×N square transform block may be predicted with reconstructed samples from a first N×N square transform block (or acurrent block), where the first N×N square transform block and the second N×N square transform block form the N×2N rectangular block. In such an example, the second N×N square transform block may use samples for prediction from the first N×N square transform block. The samples for prediction from the first N×N square transform block used for prediction of the second N×N square transform block are generally closer to the second N×N square transform block then samples from other N×2N rectangular blocks, so the intra prediction may perform better when the first N×N square prediction block is used for prediction of the second N×N square prediction block.

To avoid these issues associated with using rectangular prediction blocks, this disclosure describes reconstructing the N×N square transform discussed above before the prediction of the lower block. Then, the rectangular prediction with modified angles (explained above) is applied to the square transform blocks, which are square, not rectangular. This can have an impact on coding quality, since the new angles are defined for different dimensions (twice as large vertically) and a non-square aspect ratio of the pixels. It should be understood that in this disclosure the term rectangular may refer to non-square.

Therefore, when the new angles are applied to a square block, the prediction might be using reference samples that are beyond those regularly defined in HEVC, which uses 2N rows and columns (see FIG. 1 in the paper ‘Intra Coding of the HEVC Standard’, J. Lainema et al, of the Transactions on Circuits and Video Systems, December 2012). The content of “Intra Coding of the HEVC Standard” is incorporated by reference herein in its entirety. This issue may to need to addressed: the reference samples may need to be properly defined.

Certain techniques in accordance with this disclosure are described below. In particular, this disclosure describes the use of the new angles for square blocks when square transforms are used in 4:2:2 format. To avoid the issues described above with the new angle square blocks, at least two example techniques may be utilized. One technique may be to limit the angles, so no reference samples are used beyond the defined array. Another technique may be to extend the arrays. It is also possible to utilize both techniques. Accordingly, in some examples, a video coder (e.g., video encoder 20 or video decoder 30) may be configured to limit angles so no reference samples are used beyond the defined array. In some examples, the video coder may be configured to extend the arrays. In some examples, the video coder may be configured to limit angles so no reference samples are used beyond the defined array and extend the arrays.

Angle limitation is described below. The intra prediction angle is used to predict from a reference array, and the inverse angle used for projecting the samples to create the reference array. In some examples, the techniques may set up a limit for these values so that the reference is within the array dimensions.

For instance, in some examples, the angles above a certain threshold may be clipped. In some examples, the corresponding inverse angles may also be clipped. As one example, the intraPredAngles are defined in HEVC as [0, 2, 5, 9, 13, 17, 21, 26, 32]. The angle can also be the negative of these values. The corresponding inverse angle is defined as 32*256/angle and can take the values of [0, 4096, 1638, 910, 630, 482, 390, 315, 256].

To avoid the prediction extensions to undefined array values, in accordance with some of the techniques described herein, angles that may lead to that situation (e.g., where prediction extension lead to undefined array values) may be clipped.

In one example, the angles are clipped to the range [−32, 32], and consequently, the inverse angles are limited to be 256 minimum (except for the case in which the prediction is vertical/horizontal and the inverse angle is 0). Accordingly, in various examples, intra-prediction unit 72 (FIG. 2) or intra-prediction processing unit 94 (FIG. 3) may clip the angles used. In software, which may be running on intra-prediction unit 72 prediction processing unit 66 or intra-prediction processing unit 94 prediction processing unit 91, the following code specifies an implementation of this example:

if ((channelType == CHANNEL_TYPE_CHROMA) && (format ==
CHROMA_422))
{

intraPredAngle = bIsModeVer ? (intraPredAngle>>1) :
2*intraPredAngle;
invAngle = bIsModeVer ? 2*invAngle : (invAngle>>1);
if ( abs(intraPredAngle) > 32 )
{

intraPredAngle = signAng * 32;
invAngle = 256;

}

}
Where the part:

if ( abs(intraPredAngle) > 32 )
{
intraPredAngle = signAng * 32;
invAngle = 256;
}

is the algorithm applied in accordance with this technique. For instance, when intraPredAngle is larger than 32 or smaller than −32, the following is applied: intraPredAngle is set to 32 or −32 depending on the initial sign of the angle, and the inverse angel is set to 256.

Array extensions are described below. Alternatively, the array can be extended to have reference values even if the index is outside the dimensions of the current array. In some examples, it may be possible to extend the array by using the values of the last available reference value. That is, if the value N is the last in the current array, then this value is assumed for all the reference samples beyond the array.

One or more combinations of the above mentioned techniques is also possible. In different examples, anything described in this disclosure may be combined with anything else described in this disclosure.

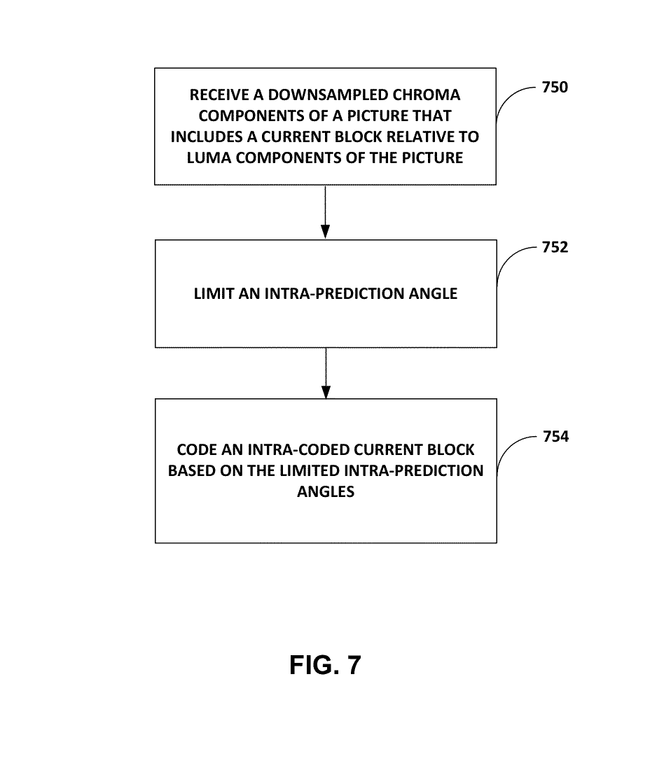

FIG. 7 is a flowchart illustrating an example method for coding video data in accordance with the systems and methods described herein. In an example a coder such as video encoder 20 or video decoder 30 may code video data in a video coding scheme having a number of intra-prediction angles. For example, video encoder 20 may encode video data in the video coding scheme having a number of intra-prediction angles and video decoder 30 may decode video data in the video coding scheme having a number of intra-prediction angles. The video coding scheme may include a 4:2:2 chroma format in some examples.

In some examples, video encoder 20 or video decoder 30 may receive a downsample chroma components of a picture that includes a current block relative to luma components of the picture (750). In some examples, intra-coding may include intra-coding downsampled chroma components of the current block. Downsampling chroma components may include downsampling chroma components prior to the at least one of limiting and extending.

Video encoder 20 or video decoder 30 may limited an intra-prediction angle to predict from a reference array in the video decoding scheme (752). For examples, intra-prediction unit 72 or intra-prediction processing unit 94 may limit the intra-prediction angle used to predict from a reference array in the video decoding scheme. The limited intra-prediction angle may be an angle that is less than the number of intra-prediction angles in the video decoding scheme. Limiting the intra-prediction angle may include clipping the intra-prediction angles and limiting inverse angels. Clipping the intra-prediction angles may include clipping the intra-prediction angles to a range of (−32, 32). This may be done, for example, when the intra-prediction angles along at least one axis have been doubled to include angles from −64 to +64. Limiting inverse angles may include limiting the inverse angles to a minimum of −256. This may be done, for example, when inverse intra-prediction angles along at least one axis have been halved to include angles from −2048 to −128. Limiting the inverse angles to the minimum of −256 may include limiting the inverse angles to the minimum of −256 when prediction is not vertical or horizontal or inverse angle is 0.

Video encoder 20 or video decoder 30 may code a chroma intra-coded current block based on the limited intra-prediction angle (754). For example, video encoder 20 may encode a chroma intra-coded current block based on the limited intra-prediction angle or video decoder 30 may decode a chroma intra-coded current block based on the limited intra-prediction angle. In some examples, intra-prediction unit 72 or intra-prediction processing unit 94 may limit the intra-prediction angle by clipping the intra-prediction angles. Intra-prediction unit 72 or intra-prediction processing unit 94 may also limit inverse angels. For example, intra-prediction unit 72 or intra-prediction processing unit 94 may limit the inverse angels by clipping.

In some examples, video encoder 20 or video decoder 30 may extend the reference array based on reference values that are outside the reference array, wherein intra-coding further comprises intra-coding the current block based on both the limited number intra-prediction angles and the extended reference array. Additionally, intra-coding 4:2:2 chroma components of the current block comprises intra-coding chroma components of a square block of a non-square block, wherein the non-square block forms the current block, and wherein the non-square block includes a plurality of square blocks.

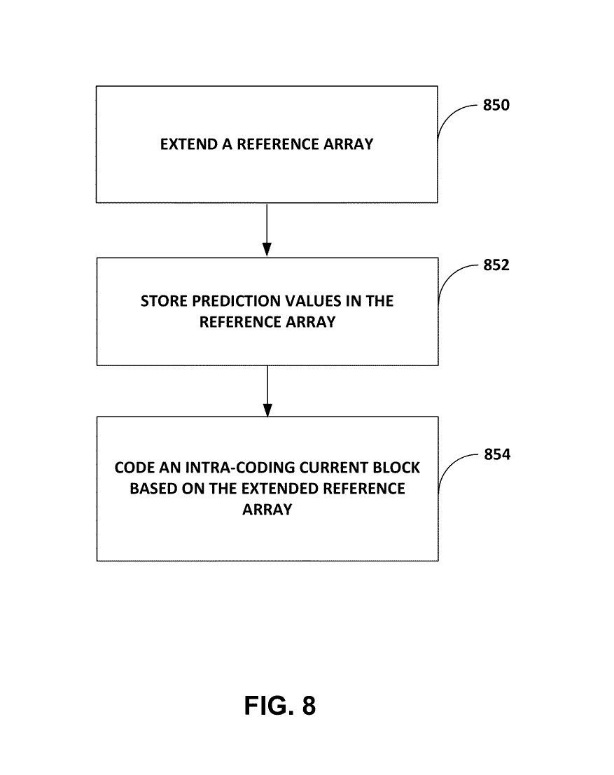

FIG. 8 is a flowchart illustrating another example method for coding video data in accordance with the systems and methods described herein. In the illustrated example of FIG. 8 video encoder 20 or video decoder 30 may extend a reference array based on reference values that are outside the reference array in a video decoding scheme including a number of intra-prediction angles (850). In some examples, extending the array further comprised extending the reference array using a last available reference value by setting the reference value of the last available reference value equal to the reference value for one or more samples beyond the reference array.

Video encoder 20 or video decoder 30 may store the intra-prediction angles in the reference array (852). In examples where the video coder extends the reference array, the video coder may extend the reference array by using a last available reference value. For example, the video coder may set the reference value of the last available reference value equal to the reference value for one or more samples beyond the reference array.

Video encoder 20 or video decoder 30 may code an intra-coding current block based on at least the extended reference array (854). For example, video encoder 20 may encode an intra-coding current block based on at least the extended reference array or video decoder 30 may decode an intra-coding current block based on at least the extended reference array. In one example, video encoder 20 codes the intra-coding current block during an encoding process. In this case, video encoder 20 may partition video date, transform the video data, quantize the video data, entropy encode the video data, and output an encoded bitstream of the video data. In another example, video decoder 30 codes the intra-coding current block during an decoding process. In this case, video decoder 30 may receive the encoded bitsteam of the video data, perform entropy decoding on the encoded bitstream, inverse quantize the decoded bitstream, and inverse transform the decoded video data.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method for decoding video data in a video decoding scheme in a 4:2:2 chroma format, the method comprising:
limiting an intra-prediction angle to predict a chroma component from a reference array, wherein the limited intra-prediction angle used varies between a value that is less than or equal to a maximum intra-prediction angle of a luma component; and
decoding a chroma intra-coded current block based on the limited intra-prediction angle.

2. The method of claim 1, wherein the limited intra-prediction angle used is larger or equal to a minimum intra-prediction angle of the luma component.

3. The method of claim 1, wherein the video decoding scheme further including a 4:2:0 chroma format, wherein the maximum intra-prediction angle in the 4:2:2 chroma format for the chroma component is the maximum intra-prediction angle in the 4:2:0 chroma format of the video decoding scheme.

4. The method of claim 1, wherein limiting an inverse intra-prediction angle used to predict the chroma component from the reference array comprise using an inverse intra-prediction angle that is larger or equal to a minimum intra-prediction angle of the luma component.

5. The method of claim 4, wherein limiting the intra-prediction angles comprises clipping the intra-prediction angles, the method further comprising:
limiting inverse angels.

6. The method of claim 5, wherein clipping the intra-prediction angles comprises clipping the intra-prediction angles to a range of (−32, 32), wherein the intra-prediction angles along at least one axis have been doubled to include angles from −64 to +64, and wherein limiting inverse angles comprises limiting the inverse angles to a minimum of −256, wherein inverse intra-prediction angles along at least one axis have been halved to include angles from −2048 to −128.

7. The method of claim 6, wherein limiting the inverse angles to the minimum of −256 comprises limiting the inverse angles to the minimum of −256 when prediction is not vertical or horizontal or inverse angle is 0.

8. The method of claim 1, wherein intra-coding 4:2:2 chroma components of the current block comprises intra-coding chroma components of a square block of a non-square block, wherein the non-square block forms the current block, and wherein the non-square block includes a plurality of square blocks.

9. The method of claim 1, further comprising:
downsampling chroma components of a picture that includes the current block relative to luma components of the picture,
wherein intra-coding comprising intra-coding downsampled chroma components of the current block.

10. The method of claim 9, wherein downsampling chroma components comprises downsampling chroma components prior to the at least one of limiting and extending.

11-12. (canceled)

13. A method for encoding video data in a video encoding scheme in a 4:2:2 chroma format, the method comprising:
limiting an intra-prediction angle to predict a chroma component from a reference array, wherein the limited intra-prediction angle used varies between a value that is less than or equal to a maximum intra-prediction angle of a luma component; and
intra-coding a current chroma block based on the limited intra-prediction angle.

14. The method of claim 13, wherein the limited intra-prediction angle used is larger or equal to a minimum intra-prediction angle of the luma component.

15. The method of claim 13, wherein the video encoding scheme further including a 4:2:0 chroma format, wherein the maximum intra-prediction angle in the 4:2:2 chroma format for the chroma component is the maximum intra-prediction angle in the 4:2:0 chroma format of the video decoding scheme.

16. The method of claim 13, wherein limiting an inverse intra-prediction angle used to predict the chroma component from the reference array comprise using an inverse intra-prediction angle that is larger or equal to a minimum intra-prediction angle of the luma component.

17. The method of claim 16, wherein limiting the intra-prediction angles comprises clipping the intra-prediction angles, the method further comprising:
limiting inverse angels.

18. The method of claim 17, wherein clipping the intra-prediction angles comprises clipping the intra-prediction angles to a range of (−32, 32), wherein the intra-prediction angles along at least one axis have been doubled to include angles from −64 to +64, and wherein limiting inverse angles comprises limiting the inverse angles to a minimum of −256, wherein inverse intra-prediction angles along at least one axis have been halved to include angles from −2048 to −128.

19. The method of claim 18, wherein limiting the inverse angles to the minimum of 256 comprises limiting the inverse angles to the minimum of 256 when prediction is not vertical or horizontal or inverse angle is 0.

20. The method of claim 13, wherein intra-coding 4:2:2 chroma components of the current block comprises intra-coding chroma components of a square block of a non-square block, wherein the non-square block forms the current block, and wherein the non-square block includes a plurality of square blocks.

21. The method of claim 13, further comprising:
downsampling chroma components of a picture that includes the current block relative to luma components of the picture,
wherein intra-coding comprising intra-coding downsampled chroma components of the current block.

22. The method of claim 21, wherein downsampling chroma components comprises downsampling chroma components prior to the at least one of limiting and extending.

23-24. (canceled)

25. An apparatus for decoding video data in a video decoding scheme in a 4:2:2 chroma format, the apparatus comprising:
a memory; and
one or more processors coupled to the memory and configured to:
limit an intra-prediction angle to predict a chroma component from a reference array, wherein the limited intra-prediction angle used varies between a value that is less than or equal to a maximum intra-prediction angle of a luma component; and
decode a chroma intra-coded current block based on the limited intra-prediction angle.

26. The apparatus of claim 25, wherein the limited intra-prediction angle used is larger or equal to a minimum intra-prediction angle of the luma component.

27. The apparatus of claim 25, wherein the video decoding scheme further including a 4:2:0 chroma format, wherein the maximum intra-prediction angle in the 4:2:2 chroma format for the chroma component is the maximum intra-prediction angle in the 4:2:0 chroma format of the video decoding scheme.

28. The apparatus of claim 25, wherein limiting an inverse intra-prediction angle used to predict the chroma component from the reference array comprise using an inverse intra-prediction angle that is larger or equal to a minimum intra-prediction angle of the luma component.

29. The apparatus of claim 25, wherein limiting the intra-prediction angles comprises clipping the intra-prediction angles, the apparatus further comprising:
limiting inverse angels.

30. The apparatus of claim 29, wherein clipping the intra-prediction angles comprises clipping the intra-prediction angles to a range of (−32, 32), wherein the intra-prediction angles along at least one axis have been doubled to include angles from −64 to +64, and wherein limiting inverse angles comprises limiting the inverse angles to a minimum of −256, wherein inverse intra-prediction angles along at least one axis have been halved to include angles from −2048 to −128.

31. The apparatus of claim 30, wherein limiting the inverse angles to the minimum of 256 comprises limiting the inverse angles to the minimum of 256 when prediction is not vertical or horizontal or inverse angle is 0.

32. The apparatus of claim 30, wherein intra-coding 4:2:2 chroma components of the current block comprises intra-coding chroma components of a square block of a non-square block, wherein the non-square block forms the current block, and wherein the non-square block includes a plurality of square blocks.

33. The apparatus of claim 30, further comprising:
downsampling chroma components of a picture that includes the current block relative to luma components of the picture,
wherein intra-coding comprising intra-coding downsampled chroma components of the current block.

34. The apparatus of claim 33, wherein downsampling chroma components comprises downsampling chroma components prior to the at least one of limiting and extending.

35-36. (canceled)

37. An apparatus for encoding video data in a video encoding scheme in a 4:2:2 chroma format, the apparatus comprising:
a memory; and
one or more processors coupled to the memory and configured to:
limit an intra-prediction angle to predict a chroma component from a reference array, wherein the limited intra-prediction angle used varies between a value that is less than or equal to a maximum intra-prediction angle of a luma component; and
intra-code a current block based on the limited intra-prediction angles.

38. The apparatus of claim 37, wherein the limited intra-prediction angle used is larger or equal to a minimum intra-prediction angle of the luma component.

39. The apparatus of claim 37, wherein the video decoding scheme further including a 4:2:0 chroma format, wherein the maximum intra-prediction angle in the 4:2:2 chroma format for the chroma component is the maximum intra-prediction angle in the 4:2:0 chroma format of the video decoding scheme.

40. The apparatus of claim 37, wherein limiting an inverse intra-prediction angle used to predict the chroma component from the reference array comprise using an inverse intra-prediction angle that is larger or equal to a minimum intra-prediction angle of the luma component.

41. The apparatus of claim 37, wherein limiting the intra-prediction angles comprises clipping the intra-prediction angles, the apparatus further comprising:
limiting inverse angels.

42. The apparatus of claim 41, wherein clipping the intra-prediction angles comprises clipping the intra-prediction angles to a range of (−32, 32), wherein the intra-prediction angles along at least one axis have been doubled to include angles from −64 to +64, and wherein limiting inverse angles comprises limiting the inverse angles to a minimum of −256, wherein inverse intra-prediction angles along at least one axis have been halved to include angles from −2048 to −128.

43. The apparatus of claim 42, wherein limiting the inverse angles to the minimum of 256 comprises limiting the inverse angles to the minimum of 256 when prediction is not vertical or horizontal or inverse angle is 0.

44. The apparatus of claim 42, wherein intra-coding 4:2:2 chroma components of the current block comprises intra-coding chroma components of a square block of a non-square block, wherein the non-square block forms the current block, and wherein the non-square block includes a plurality of square blocks.

45. The apparatus of claim 42, further comprising:
downsampling chroma components of a picture that includes the current block relative to luma components of the picture,
wherein intra-coding comprising intra-coding downsampled chroma components of the current block.

46. The apparatus of claim 45, wherein downsampling chroma components comprises downsampling chroma components prior to the at least one of limiting and extending.

47-48. (canceled)

49. An apparatus for coding video data in a video coding scheme having a number of intra-prediction angles comprising:
means for limiting an intra-prediction angle to predict a chroma component from a reference array, wherein the limited intra-prediction angle used varies between a value that is less than or equal to a maximum intra-prediction angle of a luma component; and
means for decoding a chroma intra-coded current block based on the limited intra-prediction angle.

50. (canceled)

51. A non-transitory computer readable storage medium storing instructions that upon execution by one or more processors, cause the one or more processors to:
limit an intra-prediction angle to predict a chroma component from a reference array, wherein the limited intra-prediction angle used varies between a value that is less than or equal to a maximum intra-prediction angle of a luma component; and
decode a chroma intra-coded current block based on the limited intra-prediction angle.

52. (canceled)

53. The method of claim 1, wherein the absolute value of the limited intra-prediction angle used varies between a value that is less than or equal to a maximum intra-prediction angle of a luma component.

54. The method of claim 13, wherein the absolute value of the limited intra-prediction angle used varies between a value that is less than or equal to a maximum intra-prediction angle of a luma component.

55. The apparatus of claim 25, wherein the absolute value of the limited intra-prediction angle used varies between a value that is less than or equal to a maximum intra-prediction angle of a luma component.

56. The apparatus of claim 37, wherein the absolute value of the limited intra-prediction angle used varies between a value that is less than or equal to a maximum intra-prediction angle of a luma component.
